(19) United States
(12) Patent Application Publication
(10) Pub. No.: US 2003/0076570 A1
(43) Pub. Date: Apr. 24, 2003

(54) Method, system and apparatus for optically receiving information

(75) Inventors: Marcel F.C. Schemmann, Maria-Hoop (NL); Zoran Maricevic, Manlius, NY (US); Antonije R. Djordjevic, Belgrade (YU)

Correspondence Address: Wayne F. Reinke, Esq., Heslin Rothenberg Farley & Mesiti P.C., 5 Columbia Circle, Albany, NY, 12203-5160, US

(73) Assignee: Teradvance Communications, LLC, Syracuse, NY (US)

(21) Appl. No.: 10/035,803

(22) Filed: Oct. 23, 2001

(51) Int. Cl. H04B 10/12; H04B 10/06

(52) U.S. Cl. 359/189; 359/173

(57) ABSTRACT

An optical signal is transmitted and received from an optical wave guide, the optical signal including an in-phase (I) component, a quadrature (Q) component and a carrier signal, and converted to an electrical signal. The electrical signal is phase-filtered to compensate for dispersion and phase locked.

### BACKGROUND OF THE INVENTION

1. Technical Field

The present invention generally relates to receiving an optical signal. More particularly, the present invention relates to receiving and extracting information from an optical signal.

2. Background Information

Due to increased demand for data transport capacity in recent years, systems have been developed that transport optical carrier OC-192 (10 Gbps) or similar data formats over long-haul optical fiber, such as, for example, standard single mode fiber (SMF). This type of fiber is predominant in the present installed base. Due to the dispersive properties of these fibers, data transport distance for OC-192 standard 10 Gbps rate is chromatic dispersion limited to approximately 65 km, a boundary that has been shifted to more than 300 km by the use of new fibers, such as, for example, Corning's Non-Zero Dispersion Shifted (NZ-DSF) LEAF™ fibers or Lucent's True-Wave™ NZ-DSF fibers. In order to further increase the capacity carried on a single fiber, Dense Wavelength Division Multiplexing (DWDM) systems have been developed that carry many different colors of light on a single fiber with each carrying a high data rate such as OC-192. This DWDM solution offers increased bandwidth (total data rate) without increasing the installed fiber base, which is very important from a cost standpoint. This has led to the development of systems (current state of art) that can effectively carry OC-192 data streams combined in DWDM systems that have in excess of 100 different colors such that the total system data rates exceed 100 times 10 Gbps, or 1 Tera-bit-per-second (1 Tbps).

Since the required data rates continue to increase, system designers are looking into increasing the data rates carried per wavelength beyond OC-192, such as OC-384 (20 Gbps) and OC-768 (40 Gbps). However, the higher data rate transmission systems suffer more from fiber dispersion effects due to the higher frequencies involved in transmitting the data format. For example, while the 10 Gbps dispersion limit over SMF is approximately 65 km, it drops down to 16 km for a 20 Gbps data rate and only 4 km for a 40 Gbps data rate per wavelength. Dispersion compensation means have been employed in the fiber link and in the transmitter that further raise system and installation cost and complexity. Thus, it would be helpful to compensate for dispersion in the receiver.

Therefore, as data rates continue to increase, an increasing need will be experienced for ways to transmit the data over optical fiber, as well as compensate for dispersion to avoid the fiber link and transmitter dispersion compensation means.

### SUMMARY OF THE INVENTION

Briefly, the present invention satisfies the need for transmitting data over optical fiber by providing a transmitter and receiver for sending/receiving an optical signal with in-phase (I) and quadrature (Q) components, and phase locking them. In addition, a phase filter is provided in the receiver for dispersion compensation.

In accordance with the above, it is an object of the present invention to provide a receiver for receiving an optical signal having digital information.

The present invention provides, in a first aspect, a method of receiving digital information from an input optical signal, comprising receiving an optical signal containing digital information, the optical signal including a carrier signal, an I component and a Q component. The method further comprises phase locking the I component and the Q component.

The present invention provides, in a second aspect, a receiver for receiving digital information from an optical signal. The receiver comprises an optical receiver for receiving an optical signal including a carrier signal, an I component and a Q component, and a phase lock for locking the I component and the Q component.

The present invention provides, in a third aspect, apparatus to compensate for optical signal dispersion from an optical wave guide of known length, comprising a phase filter having a group delay substantially opposite that of the optical wave guide.

The present invention provides, in a fourth aspect, a method of compensating for dispersion of an optical signal from an optical wave guide of known length, comprising applying additional dispersion having a group delay substantially opposite that of the optical wave guide.

The present invention provides, in a fifth aspect, a system for optically transferring information. The system comprises a transmitter for transmitting an optical signal comprising a carrier signal, an in-phase (I) component and a quadrature (Q) component, an optical wave guide for transferring the optical signal, and a receiver. The receiver comprises an optical receiver for receiving the optical signal, and a phase lock for locking the I component and the Q component.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 is a high-level block diagram of one example of an optical communication system in accordance with the present invention.

FIG. 2 is a more detailed block diagram of the system of FIG. 1.

FIG. 3 is a block diagram of another optical communication system in accordance with the present invention.

FIG. 4 is a block diagram of another example of an optical communication system in accordance with the present invention.

FIG. 5 is a block diagram of a variation in design of the system of FIG. 4.

FIG. 6 is a block diagram of a variation in design of the system of FIG. 3.

FIG. 7 depicts a signal spectra for explaining the general operation of the systems of FIGS. 3-6.

FIG. 8 is a high-level block diagram of one example of a receiver in accordance with the present invention.

FIG. 9 is a block diagram providing more detail for the receiver of FIG. 8.

FIG. 10 is a plan view of one example of a phase filter shown in block form in FIG. 9.

FIG. 11 is a cross-sectional view of the phase filter of FIG. 10 taken along lines 11-11.

FIG. 12 is a graph of group delay for the phase filter of FIG. 10 in the frequency range of 20-40 GHz.

FIG. 13 is a graph of scattering parameters for the phase filter of FIG. 10 in the frequency range of 20-40 GHz.

FIG. 14 is a graph of a quadrature amplitude modulation constellation for one example of an optical signal.

FIG. 15 is a block diagram of one example of a reference signal generator shown in FIG. 9.

FIG. 16 is a block diagram of another example of a reference signal generator shown in FIG. 9.

FIG. 17 is a flow diagram for the operation of the computing unit in FIG. 16.

### DETAILED DESCRIPTION OF THE INVENTION

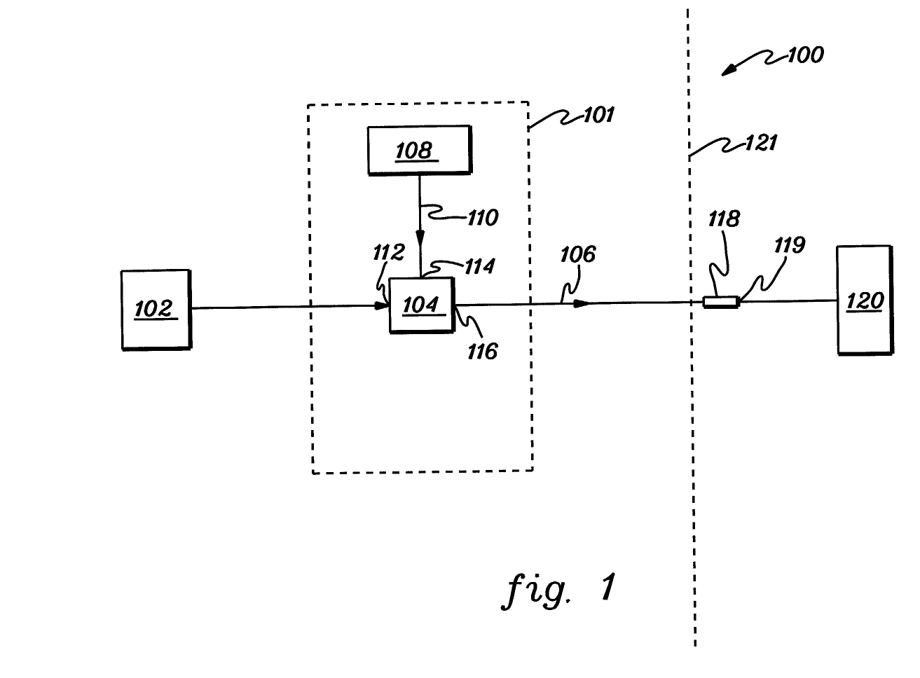

FIG. 1 shows an optical communication system 100. A transmitter 101 in accordance with the invention comprises a radiation source 102 for generating coherent light, modulator 104, for generating an optical carrier signal 106, and an electrical signal generator 108 for generating an electrical carrier signal 110. The radiation source is preferably implemented by a laser diode to generate coherent radiation. The transmitter could, for instance, be implemented on a single crystal. The modulator has an optical input 112 which receives the light from the radiation source. The light may be visible light or invisible light; that is to say, light having frequencies which can not be seen by human beings. The modulator also has an electrical input 114 which receives the electrical carrier signal. The modulator further has an optical output 116 for delivering the optical carrier signal. The optical carrier signal is modulated by the electrical carrier signal and can be put onto a waveguide, such as, for example, a long-haul optical fiber 118. While various kinds of optical wave guides can be used, even free space, a long-haul optical fiber is typically used for long distance applications. As used herein, the term “long-haul optical fiber” refers to any type of optical fiber that is or becomes applicable for use at data rates of more than 2.5 Gb/s and at distances of more than several kilometers (e.g., standard single-mode optical fiber and non-zero dispersion-shifted optical fiber).

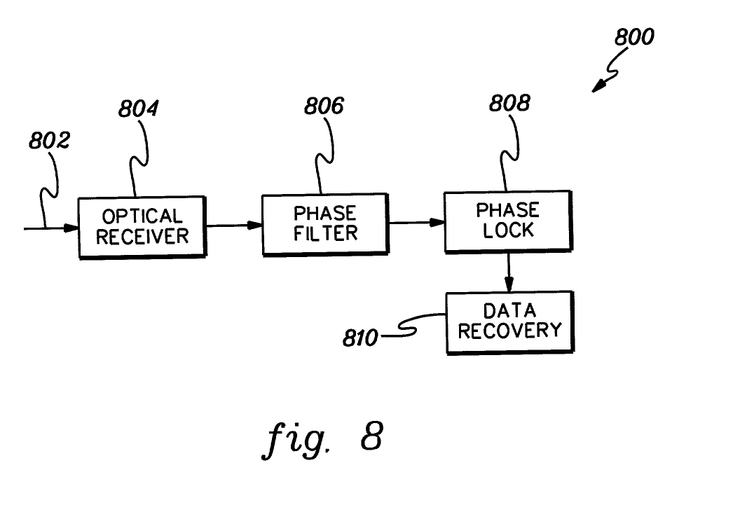

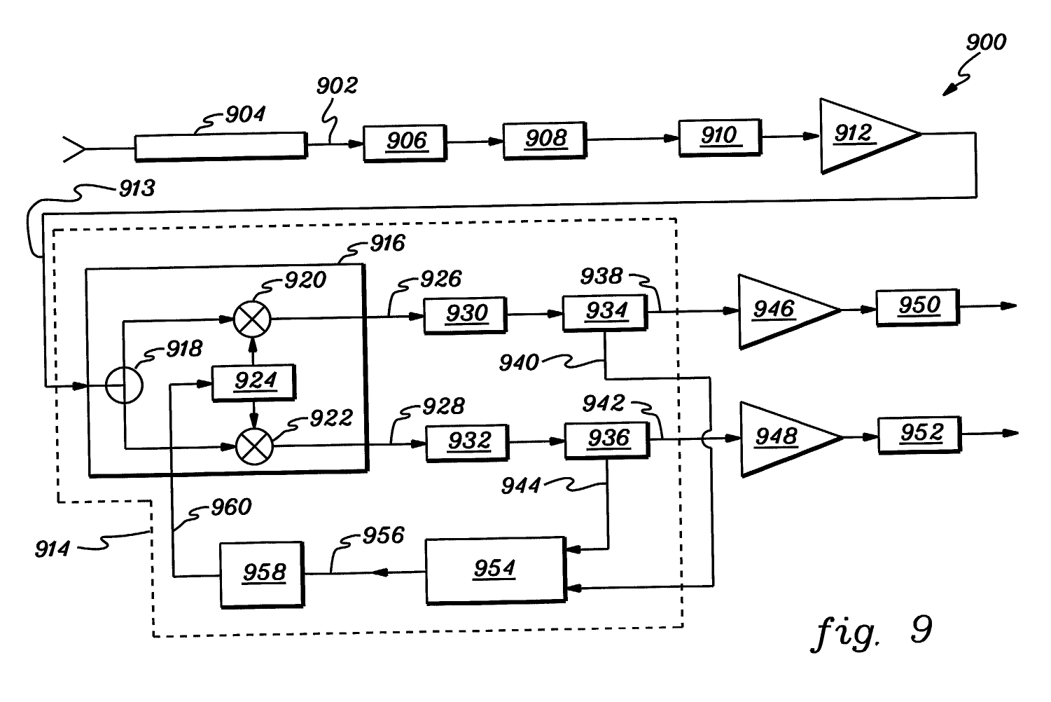

At an output 119 of the fiber, a receiver 120 can be coupled for recovery of the electrical carrier signal from the optical carrier signal. One example of the receiver will subsequently be described in detail with respect to FIGS. 8 and 9. In FIG. 1, the optical fiber and the receiver are shown at the right (receiver) side of vertical striped line 121, while the elements to the left of the line are on the transmission side. The electrical carrier signal has a fixed basic frequency. Therefore, the optical carrier signal does not comprise any data in this example. The optical carrier signal may be used in conjunction with one or more optical signals which are modulated with data to be transferred via the optical fiber to the receiver. Thus, the optical carrier signal may be used by the receiver for locking at the frequency of the electrical carrier signal, which is derived from the optical carrier signal.

In order to increase the data rates of optical signals as much as possible, the optical carrier signal is typically modulated with an electrical carrier signal having a frequency as high as possible. For this reason, the modulator and the electrical signal generator may be (but is not necessarily) constructed such that the optical carrier signal is modulated by the second harmonic of the electrical carrier signal. If so constructed, the optical carrier signal is thus modulated with a modulation frequency which is twice the frequency of the fixed basic frequency. The generation of the second harmonic from the electrical carrier signal can be obtained by any known manner. It will be understood, however, that the first order harmonic, or a harmonic higher than the second could instead be used.

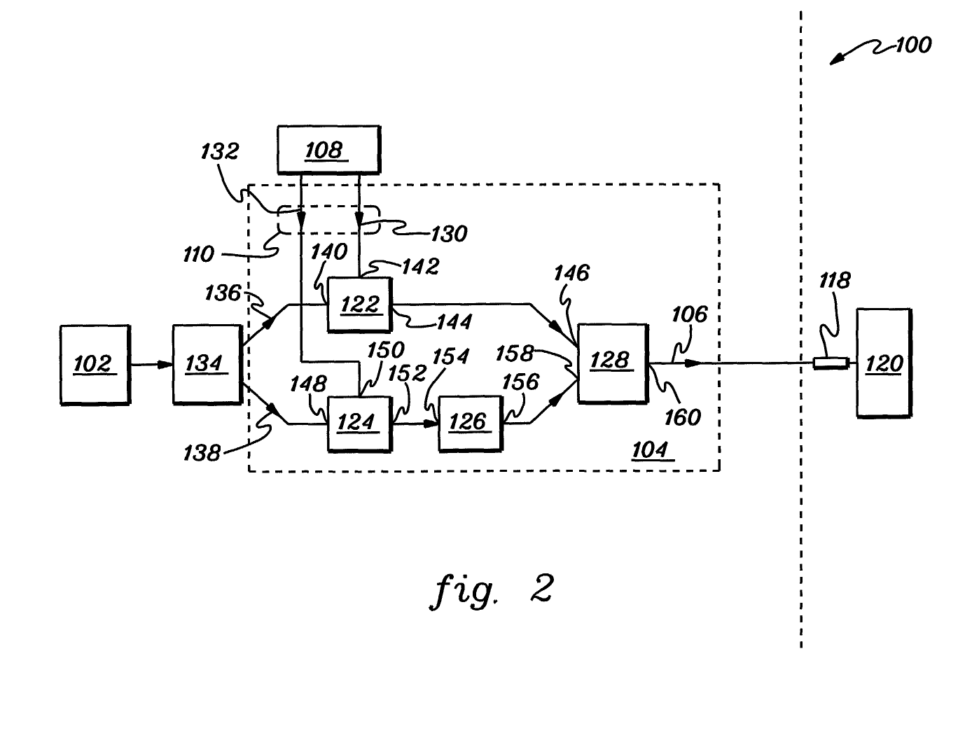

One example of the generation of the second harmonic from the electrical carrier signal 110 is provided in FIG. 2. The modulator is by way of example, implemented by phase modulator 104 and comprises a first optical modulator 122, a second optical modulator 124, a first optical phase shifter 126, and a first optical combiner 128. The electrical carrier signal 110 comprises a first electrical carrier signal 130 and a second electrical carrier signal 132. The light from the laser 102 is split by a first optical splitter 134 into two parts 136 and 138. The first phase modulator has an optical input 140 which receives one of the two parts of the light (here, part 136), an electrical input 142 which receives electrical carrier signal 130, and an output 144 which is coupled to a first input 146 of combiner 128. The second phase modulator has an optical input 148 which receives the other one of the two parts of the light (here, part 138), an electrical input 150 which receives the second electrical carrier signal, and an output 152 which is coupled to an input 154 of phase shifter 126. An output 156 of phase shifter 126 is coupled to a second input 158 of combiner 128. An output 160 of combiner 128 delivers the optical carrier signal 106.

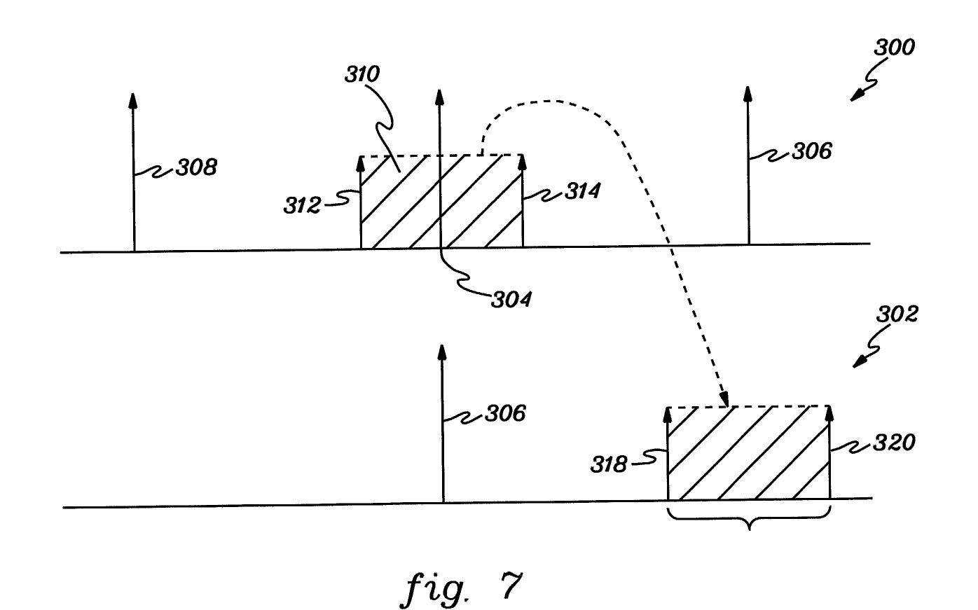

Optical phase shifter 126, the function of which can be accomplished, for example, by a section of wave guide, produces either no shift (i.e., 0 degrees) or a 180 degree shift of the signal out of optical modulator 124, depending on the frequency of electrical carrier signal 132 and how far from the data the side carrier frequency is, i.e., one or two times the frequency of signal 132 (see description of FIG. 7 for side carrier discussion). For example, if the electrical carrier signal frequency is 15 GHz, and the side carrier frequency needs to be 2×15 GHz=30 GHz away from the data, then the optical phase shifter needs to produce a zero degree shift; that way, the needed −30 GHz, 0 GHz and +30 GHz signals are created, while the “odd order” −15 GHz and +15 GHz are canceled. As another example, if the electrical carrier signal frequency is 30 GHz, and the side carrier still needs to be 1×30 GHz=30 GHz away from the data, the need for a 180 degree shift results. With a 180 degree shift, the needed −30 GHz and +30 GHz signals are created while “even order” −60 GHz, 0 GHz and +60 GHz signals are canceled.

The amplitudes of electrical carrier signal 130 and electrical carrier signal 132 are approximately the same, while the phases thereof are approximately opposite. With this measure, and the proper value for the phase shift by phase shifter 126 (here, zero degrees relative to the signal out of optical modulator 122), no odd harmonics are present at the output 160 of combiner 128. This is because the odd harmonics, which include the basic frequency (1^{th} order), are canceled, or at least sufficiently suppressed. The even harmonics are not canceled. Because of the fact that the second order harmonic strongly dominates over the higher order even harmonics, the frequency (relative to the frequency generated by the laser) by which the optical carrier signal is modulated is twice as high as the frequency of either of carrier signals 130 and 132. As one skilled in the art will know, a phase shift of 180 degrees cancels even harmonics. Thus, for example, if the electrical carrier frequency is 30 GHz, then −30 GHz and +30 GHz signals are generated, with −60 GHz, 0 GHz and +60 GHz being suppressed.

At the outputs of the phase modulators, odd and even harmonics may be generated. The mutual amplitudes and phases of the harmonics can also be chosen in a way that at the output of combiner 128, the odd harmonics, which include the basic first order frequency, are canceled. The even harmonics are not canceled. However, the second order harmonic dominates. Therefore, the frequency (relative to the frequency generated by the laser diode) of the optical carrier signal is about twice the frequency of the carrier signals. This has the advantageous effect that the optical carrier signal is modulated with a frequency which is twice the basic frequency. Thus, if the basic frequency is chosen to be the maximum obtainable frequency in the current state of the art, the maximum modulation frequency of the optical carrier signal is still doubled.

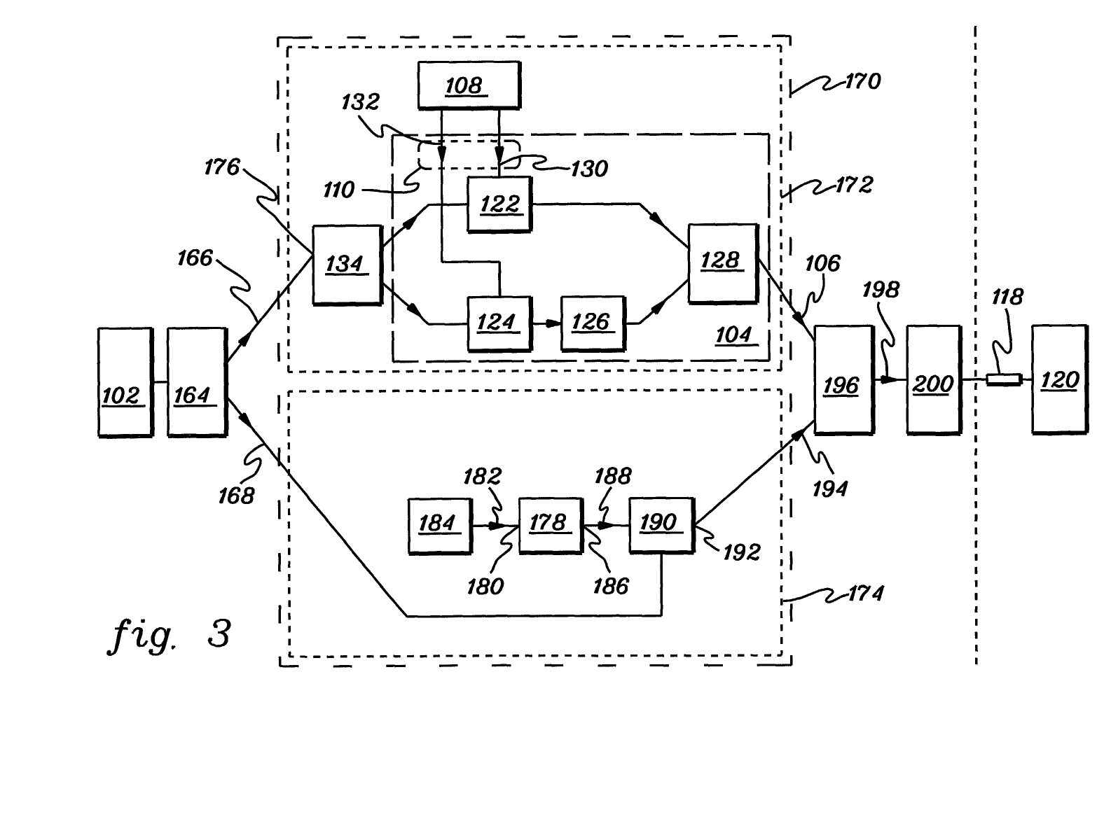

FIG. 3 depicts one example of an optical transmitter 170 in accordance with the present invention, building on that shown in FIG. 2. Light from laser 102 is first split by a second optical splitter 164 into two parts, 166 and 168. The transmitter 170 comprises a first branch 172 and a second branch 174. The first branch comprises phase modulator 104, the electrical signal generator 108, and splitter 134 from FIG. 2. The input 176 of splitter 134 receives part 166 of the light from the laser. The second branch 174 comprises modulator driver 178 having an input 180 for receiving an electrical data signal 182 generated by a data signal generator 184, and an output 186 for sending a drive signal 188 to an amplitude modulator 190. Amplitude modulator 190 also receives part 168 of the light. Modulator 190 further comprises an output 192 coupled to deliver an optical data signal 194 to another combiner 196, which also receives optical carrier signal 106. Amplitude modulator 190 is, by way of example, implemented by a so-called Mach-Zehnder interferometric modulator. The splitting of the radiation into the first and second part enables the possibility of using the first and second branch for separate radiation modulation functions. The first branch can be used to create the optical carrier signal while the second branch can be used to create the optical data signal. This has the advantageous effect that the first branch can be optimized in order to create a very high possible modulation frequency of the optical carrier signal without a penalty with respect to performances of the data signal.

The first and second polarization states, respectively, of the optical carrier signal and the optical data signal are matched by a matching means in a manner that the first and second polarization states are substantially equal. This matching can, for instance, be accomplished with polarization maintaining fibers for one or more of the connections between the optical elements of the transmitter. However, it is not strictly necessary to use polarization maintaining fibers. Polarization states in between the several optical elements may be different as long as the polarization of the optical carrier signal and the optical data signal are approximately the same. In addition, another way to accomplish polarization state matching is to manufacture all needed splitters, phase modulators, phase shifters, combiners, etc., from a single crystal of, for example, Lithium Niobate. This would eliminate the need for separate polarization state matching. Conventional techniques can be used to put the needed elements on a single crystal.

Amplitude modulator 190 is, for example, an external optical modulator for modulating part 168 of the light by data derived from electrical data signal 182, via modulator driver 178. Modulator driver 178 may be, for example, an oscillator which is modulated by electrical data signal 182. Modulator driver 178 may instead be an amplifier. Although various kinds of external optical modulators can be implemented for amplitude modulator 190, a Mach-Zehnder interferometric modulator is preferred, because such Mach-Zehnder modulators are widely used in industry. The combined light signal 198 coming from combiner 196 comprises the optical carrier signal 106 and the optical data signal 194 and is thus equivalently modulated by a complete (carrier+data) RF-signal. This combined light is transferred via optical fiber 118 to the receiver 120. Preferably, before transmitting this combined light over optical fiber 118, the combined light is first filtered through an optical filter 200 in order to remove unwanted (spurious) signals. Alternatively, the optical carrier signal can be filtered prior to combiner 196.

The radiation coming from combiner 196 forms an optical signal modulated by a total RF-signal; that is to say, an RF-signal having one or more unmodulated RF-carriers and having RF-signals with information representing the data of the (first) electrical data signal. The radiation coming from the output of the second combiner is ready for transmission over the wave guide (here, fiber 118). The radiation coming from the output of the wave guide can be coupled to an optical receiver (here, receiver 120). This receiver can then use the optical carrier signal for mixing (detecting) the data and carrier signals and locking at the carrier frequency offset relative to the data.

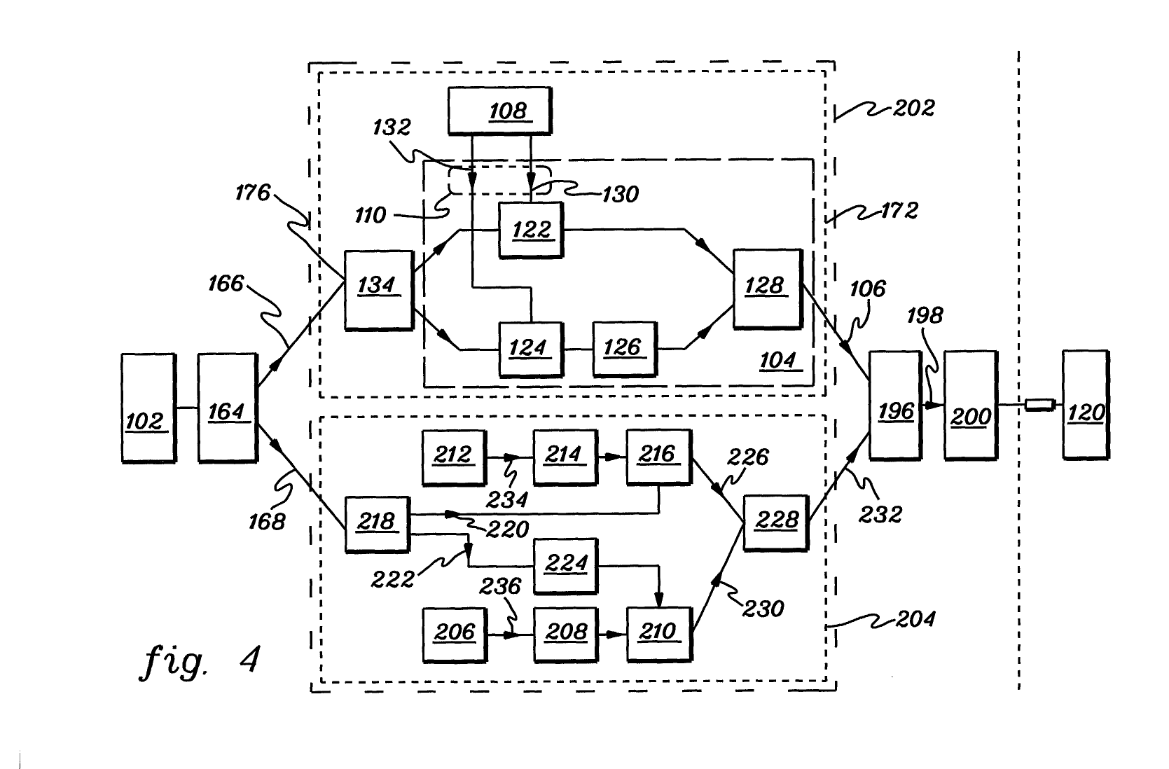

FIG. 4 depicts another embodiment of an optical transmitter 202 in accordance with the invention, replacing branch 174 of FIG. 3. In this embodiment, branch 204 comprises a second group of data signal generator, modulator driver and optical modulator as compared to FIG. 3. Data signal generator 206, modulator driver 208 and optical amplitude modulator 210 are coupled in the same way as the corresponding trio in FIG. 3 (here, data signal generator 212, modulator driver 214 and optical modulator 216), and also have like functions. Part 168 of the light is further split by another splitter 218 into parts 220 and 222. Thus, modulator 216 is now coupled to receive part 220 of the light, while modulator 210 is coupled to receive part 222 of the light via another optical phase shifter 224, the function of which, like optical phase shifter 126, may be accomplished by a section of wave guide. Modulator 216 delivers an optical data signal 226 to a combiner 228. Modulator 210 also delivers an optical data signal 230 to combiner 228. A combined optical data signal 232 is delivered from combiner 228 to combiner 196. The phase shift performed by phase shifter 224 is about 90 degrees with respect to part 220 out of splitter 218. Optical data signals 226 and 230 are modulated in quadrature by electrical data signals 234 and 236, respectively. In the electronics field, quadrature signals are generally referred to as I (in-phase) and Q (quadrature) signals. By this quadrature modulation technique, the information representing the data of electrical data signal 234 is not confused with the data of electrical data signal 236, despite the fact that the frequencies corresponding with the electrical data signals lie within the same frequency band. Thus, by the application of the quadrature modulation technique, the total amount of information which can be transferred is further doubled.

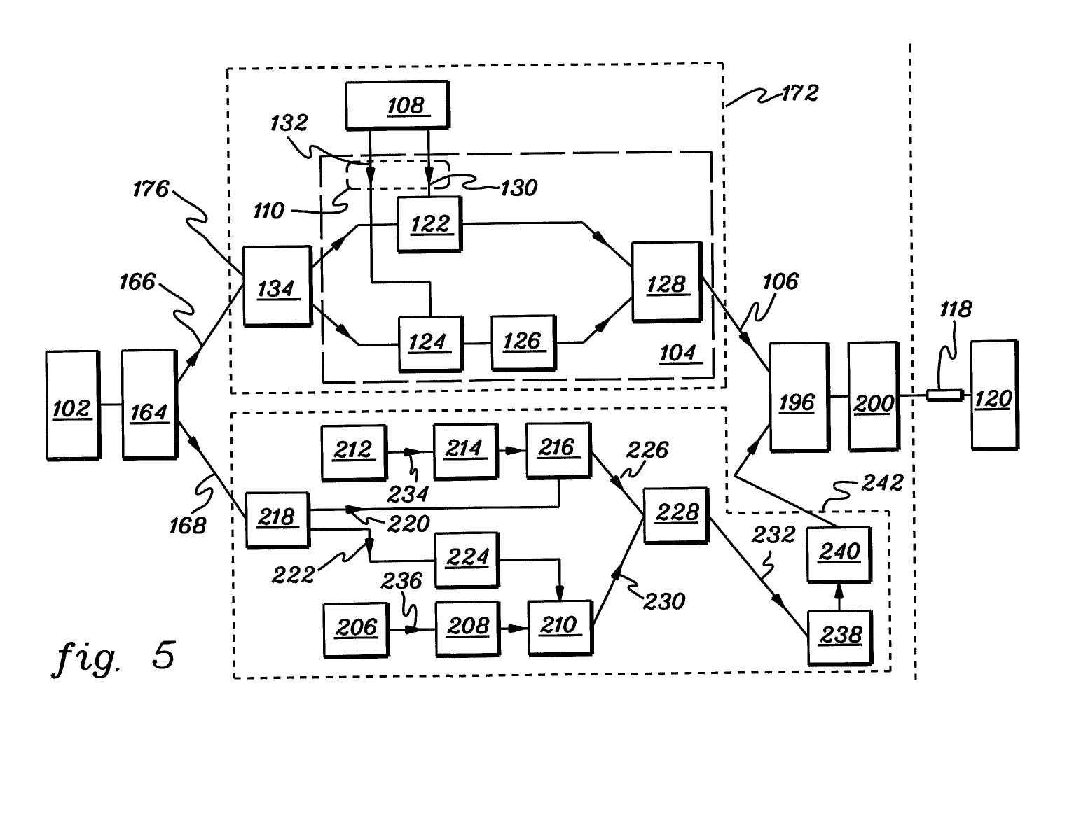

FIG. 5 depicts a variation of branch 204 in FIG. 4. In this variation, another optical phase shifter 238, similar to optical phase shifter 224, and an attenuator 240 are arranged between combiner 228 and combiner 196. The additional shifter and attenuator equalize (or partially equalize) the optical amplitudes between branches 172 and 242, offsetting their respective phases by 180 degrees with respect to each other, for total (or partial) cancellation of residual unmodulated light in part 168 out of data branch 242. Phase shifter 238 and optical attenuator 240 can also be arranged in the other (first) branch. The attenuator is less complex and more economical than amplifying the amplitude. The attenuator must, however, be arranged in the branch having the highest amplitude. So, for instance, phase shifter 238 can also be arranged between splitter 164 and splitter 134, while the attenuator remains at the position shown in FIG. 5.

The FIG. 5 embodiment makes it possible to completely cancel the frequency of the radiation source by controlling the amplitude of optical attenuator 240 and the phase of optical phase shifter 238. This has the advantageous effect that the total radiation energy injected onto the wave guide (here, optical fiber 118) is reduced without any loss of information. It is, however, possible to cancel only a large portion of the frequency of the radiation source. The remaining portion only gives rise to an almost negligible amount of increased radiation energy compared to total cancellation, in which the frequency of the radiation source is completely suppressed.

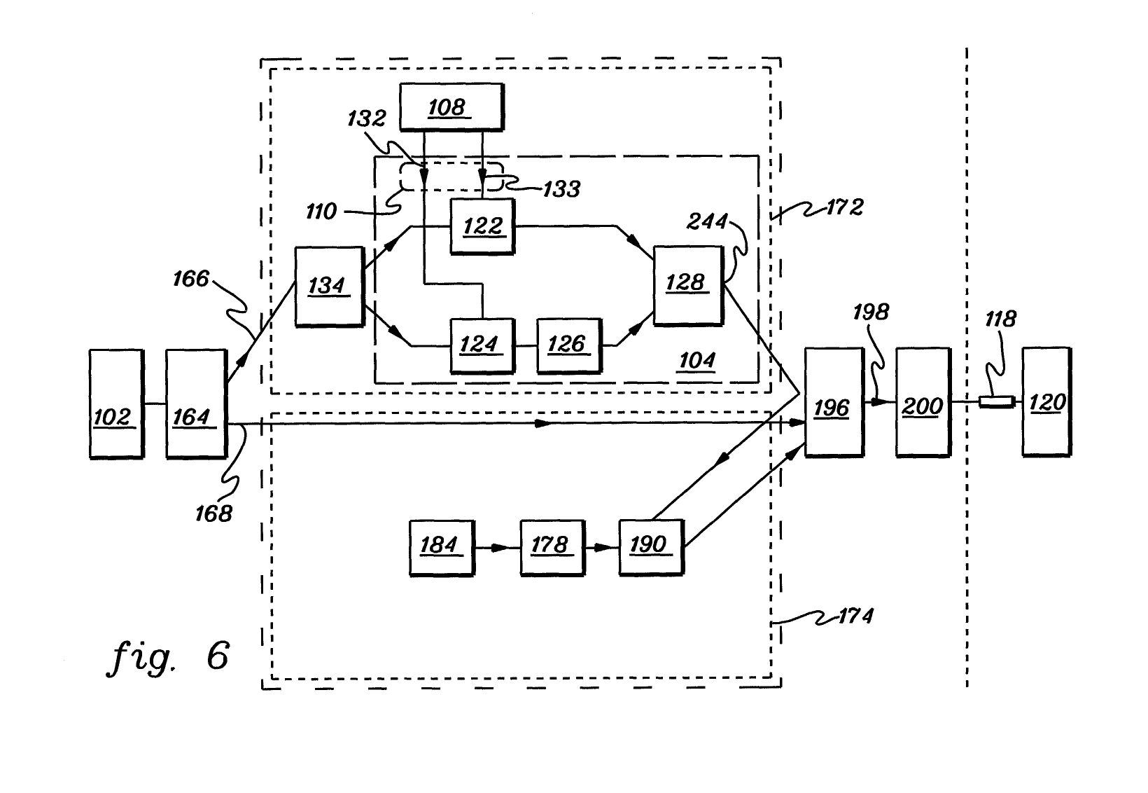

FIG. 6 depicts a variation of the system of FIG. 3. One difference between the systems of FIG. 6 and FIG. 3 is that FIG. 6 provides part 168 of the light having a first polarization state, out of splitter 164 directly to combiner 196. The output 244 of combiner 128, having a second polarization state, is provided to amplitude modulator 190, while part 168 from splitter 164 is provided directly to combiner 196 along with the output of amplitude modulator 190, having a third polarization state. The first polarization state of part 168 and the third polarization state of the output of amplitude modulator 190 are matched and combined by combiner 196. The principle of this variation can also be applied to the embodiments shown in FIGS. 4 and 5. In FIG. 6, the filter 200 can be used to remove unwanted RF modulated carriers from the optical output spectrum and/or to remove unwanted unmodulated carriers, leaving one modulated carrier and one reference signal out of the radiation source. In one embodiment, the frequency of electrical carrier signals 130 and 132 are 30 GHz and optical phase shifter 126 is set for cancellation of even order harmonics. Therefore, the signal from output 244 of combiner 128 is composed of two carriers, each 30 GHz to the left and right side of the frequency of radiation source 102. Amplitude modulator 190 (or a quadrature modulating branch as in FIG. 4) imprints 10 Gbps (20 Gbps if quadrature used) onto both −30 GHz and +30 GHz carriers. This spectrum is combined with part 168 out of splitter 164, at 0 GHz relative to the radiation source frequency. Filter 200 would remove one of the modulated carriers, for example, one at −30 GHz relative to the radiation source frequency.

The embodiments shown in FIGS. 3-6 will now further be explained in conjunction with the signal spectra 300 and 302 of FIG. 7. By way of example, it is assumed that the basic frequency of electrical signals 130 and 110 is equal to 15 GHz with respect to FIGS. 3-5, or equal to 30 GHz with respect to FIG. 6. In order to avoid distortion caused by second order intermodulation, the frequencies generated at the outputs of the modulator drivers (e.g., 214 and 208 in FIG. 4) are preferably not higher than 10 GHz in this example. The frequencies indicated in spectrum 300 of FIG. 7 are relative to the frequency 304 of the (unmodulated) light coming from the laser. Optical carrier signal frequencies 306 and 308 of +30 GHz and −30 GHz from the data band center, respectively, are generated. The single offset frequency, in general, comprises an integer multiple of half the bit rate. One of these +30 GHz and −30 GHz signals may be filtered away by filter 200. In FIG. 7, it is indicated that the data 310 is comprised in the frequency range between frequency 312 of −10 GHz and frequency 314 of +10 GHz. In this example, the frequency range of −10 GHz up to +10 GHz is in fact a Double Side Band (DSB) signal which is, however, in its entirety at one side of the +30 GHz signal (or the −30 GHz signal). Thus, the DSB signal may be interpreted as a Single Side Band signal in relation to the optical carrier signal. The receiver 120 will lock onto the spectrum 302 +30 GHz signal in order to mix this signal with the data. Spectrum 302 shows part of the spectra which will be available in the receiver after locking on the +30 GHz signal. The data signal is available in the frequency range 316 of +20 GHz (318) up to 40 GHz (320), relative to frequency 306, and thus lies substantially within one octave. Any possible second order intermodulation products will fall into unoccupied frequency regions and, thus, cannot lead to a distortion of the transferred information.

So far, the optical carrier signal is by way of example described as a signal which does not comprise any information. It is, however, emphasized that the optical carrier signal may be modulated by an electrical signal comprising information. Thus, the optical carrier signal may carry signal spectrum. In such case, unmodulated light from the laser may, if desired, act as the (reference) carrier for the signal spectrum.

The problems caused by dispersion, for example, of standard single mode fiber, can be reduced significantly by adopting a special modulation scheme employing Quadrature Amplitude Modulation (QAM). As one skilled in the art will know, the term “dispersion” as used herein means chromatic dispersion. The modulation scheme comprises a Phase Locked Loop (PLL) at the receive side, operating at 30 GHz in this example, locking to the incoming signal which contains a carrier signal, in this example a single frequency 30 GHz off-set from the data band. Those skilled in the art will understand that frequencies other than 30 GHz can be used. A choice of an integer multiple of half the bit rate makes it possible to readily derive the carrier frequency from the data clock frequency. Commonly in QAM systems the locking is done via frequency doubling, which would lead to excessive high frequencies and complexity here. For further information on frequency doubling, see, for example, John G. Proakis, “Digital Communications,” second edition, section 4.5, McGraw-Hill 1989. Thus, a different PLL locking scheme is devised herein.

FIG. 8 is a high-level block diagram of one example of a receiver 800 in accordance with the present invention. An optical signal 802 from an optical wave guide, such as, for example, long-haul optical fiber (not shown) is received by an optical receiver 804 for conversion into an electrical signal. The optical signal (and the electrical representation thereof) comprises in-phase and quadrature components, each of which comprises a Radio Frequency (RF) portion and a Direct Current (DC) portion. Digital data included in the optical signal is embedded in the RF portions. As described in more detail subsequently, a phase filter 806 compensates for dispersion caused by the long-haul optical fiber. Phase lock 808 locks the phase of the in-phase and quadrature components of the electrical signal. Once locked, the digital data is extracted by data recovery element 810.

FIG. 9 is a block diagram providing details of one example implementation of a receiver 900 based on the high-level block diagram of FIG. 8. For the following description, assume that the information of interest is contained within a frequency range of 20-40 GHz (i.e., one octave), relative to the side carrier, at a data rate of 20 Gb/s (gigabits per second). See the discussion of FIG. 7 above. An optical signal 902 from, for example, long-haul optical fiber 904 is received and converted into an electrical signal by optical receiver 906. One example of an optical receiver is a photo-detector. A filter 908 ensures that only the frequency range of interest is passed from the optical receiver, while all second order distortions fall outside of this band. In one scenario, the optical receiver only receives optical signals up to a frequency of 40 GHz, and the filter passes frequencies of 20 GHz and above. Together, the optical receiver and high-pass filter act as a band pass filter. In another scenario, the filter is a band pass filter passing frequencies between 20 and 40 GHz.

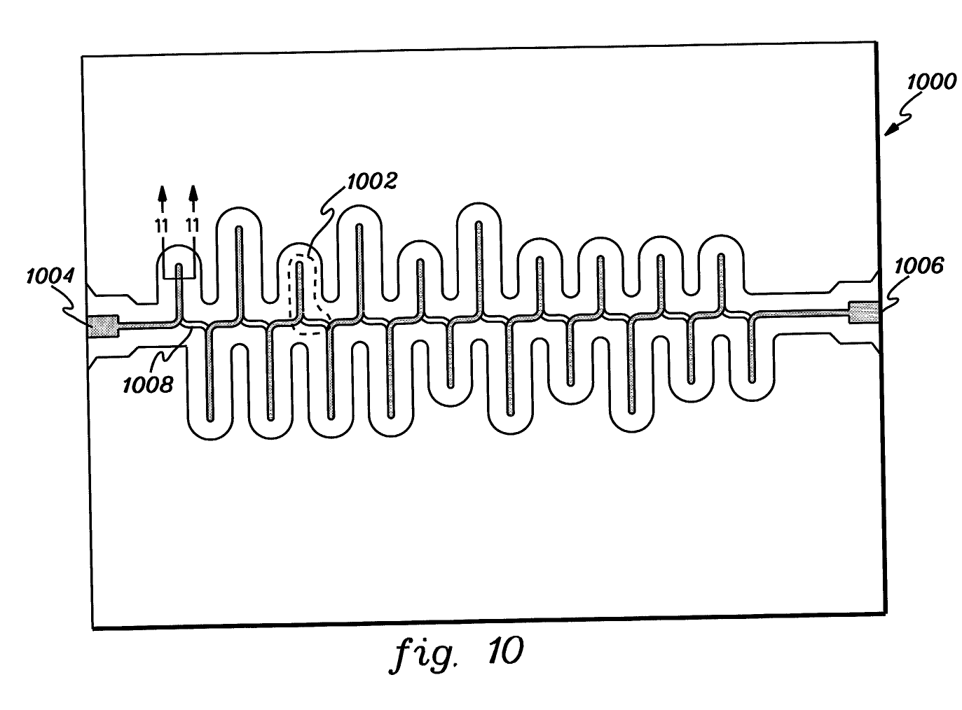

Phase filter 910 compensates for dispersion from the long-haul optical fiber of known length by applying additional dispersion with a group delay response substantially opposite that of the long-haul optical fiber, effectively canceling out the dispersive effects of the long-haul optical fiber. FIG. 10 is a plan view of one example of a phase filter 1000 (also referred to as a dispersive delay line filter) in accordance with the present invention.

Phase filter 1000 comprises broadside-coupled microwave strip lines, and compensates for 80 km of standard single mode fiber. It will be understood that 80 km of standard single mode optical fiber is merely one example. A longer length of fiber would, of course, require a longer phase filter with more broadside-coupled microwave strip lines. Phase filter 1000 comprises 20 cascaded unit cells of various lengths, such as, for example, unit cell 1002, an input 1004 and an output 1006. Each cell comprises two strongly coupled transmission lines (here, broadside-coupled microwave strip lines). In series with the coupled transmission lines for each cell is a section (e.g., section 1008) of a 50 ohm strip line to provide interconnections and separations between adjacent coupled transmission lines. Hence, a complete unit consists of a cascade of two broadside coupled transmission lines and interconnecting strip lines. Filter 1000 consists of 20 such units of various lengths; 11 units are 1.8 mm long and 9 units are 2.8 mm long. The units are randomly ordered to break down the periodicity of the structure and thus reduce sensitivity to tolerances.

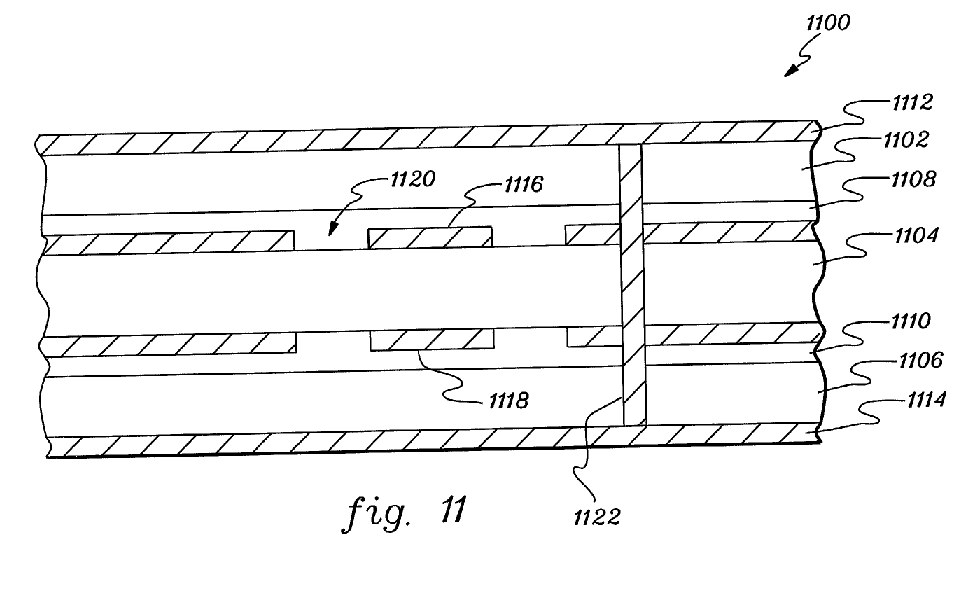

FIG. 11 is a cross-sectional view of phase filter 1000 from FIG. 10, taken along lines 11-11. Three dielectric layers 1102, 1104 and 1106 are held together by low dielectric loss prepreg layers 1108 and 1110. The dielectric layers are, for example, 0.13 mm thick, coupled by, e.g., 0.04 mm thick prepreg layers. On the outer faces of dielectric layers 1102 and 1106 are metalization layers 1112 and 1114, respectively. Middle dielectric layer 1104 carries the coupled printed traces 1116 and 1118 on its upper and lower faces, respectively. The coupled printed traces are, for example, 0.25 mm wide and, in this case, precisely aligned. On either side of the printed traces, for example, in area 1120, the metalization layers have been etched away (e.g., using a chemical etch). A via 1122 connects the various metalization layers to ground.

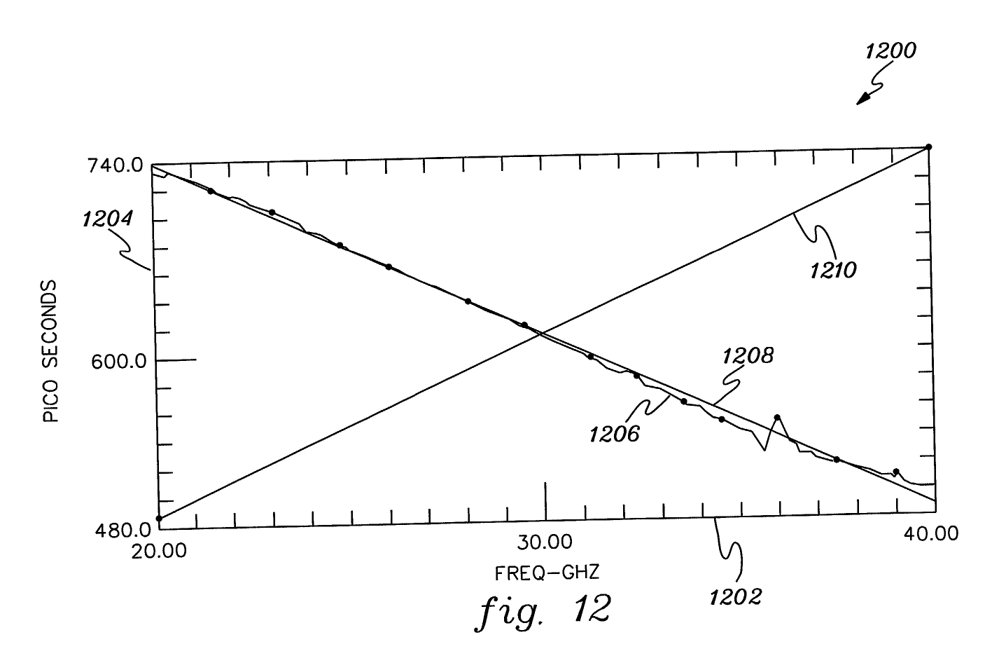

FIG. 12 is a graph 1200 of group delay for the phase filter of FIG. 10 in the frequency range of 20 to 40 GHz for use with a data rate of 10 Gb/s over standard single mode optical fiber with dispersion of about 340 ps. Along the X axis 1202 is the frequency in GHz, while the Y axis 1204 is the group delay in units of picoseconds. Line 1206 in the graph is the group delay based on a computer model, while line 1208 is the goal group delay, which is simply a best-fit straight line, that will be used to calculate slope. The filter applies a group delay with a substantially opposite slope 1210 in order to compensate for line 1206. As used herein with respect to group delay slope, the term substantially refers to a slope that compensates for enough of the optical fiber dispersion for a given fiber type and length to facilitate error-free bit detection. The slope of line 1208 is given by:

Slope=Dispersion×(High Filter Frequency−Low Filter Frequency)×Fiber Length;

where:

Dispersion=17 ps/(nm*km), and 1 nm=125 GHz;

High Filter Frequency=40 GHz;

Low Filter Frequency=20 GHz; and

Fiber Length=Length in km

In this case,

Slope=2.72 ps/km.

Thus, for standard single mode optical fiber of length 80 km and a data rate of 10 Gb/s, for example, the slope for group delay of the phase filter would need to be 218 ps (i.e., 2.72 ps/km×80 km) in the opposite direction over the 20-40 GHz frequency bandwidth. It will be understood that the slope formula above will work for data rates other than 10 Gb/s, such as, for example, 2.5 Gb/s and 40 Gb/s.

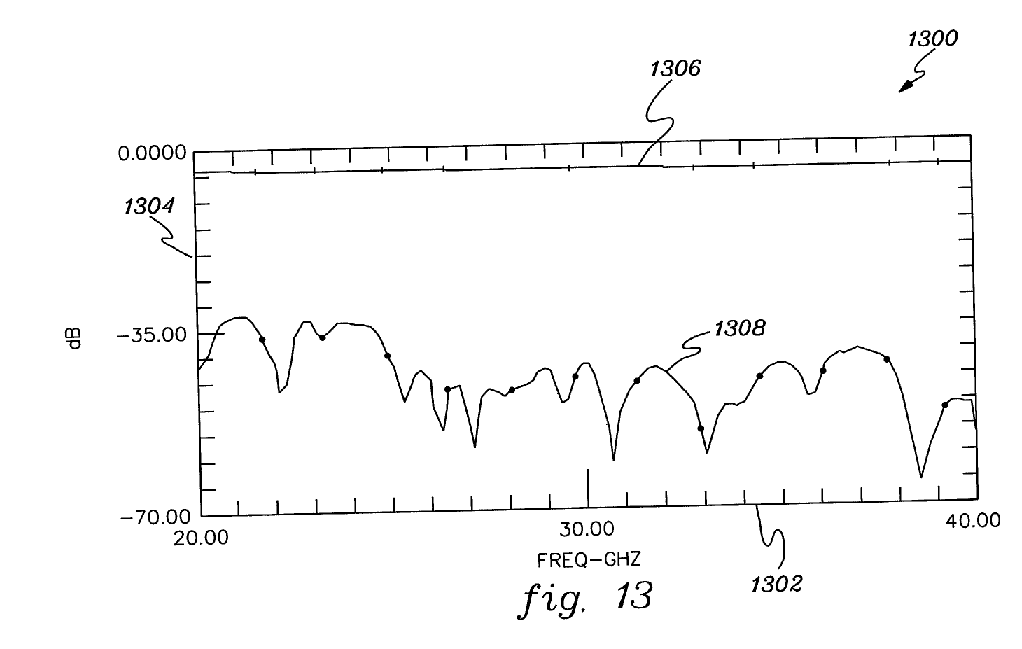

FIG. 13 is a graph 1300 of amplitude of scattering parameters for the phase filter of FIG. 10 in the frequency range of 20-40 GHz at a data rate of 10 Gb/s. As with graph 1200, frequency in GHz is shown along the X axis 1302, while the Y axis 1304 has units of decibels. Line 1306 plots insertion loss for the phase filter, which indicates that the signal attenuates about the same across the frequency range. Line 1308 plots return or reflection loss, which indicates how much of the input signal is reflected back. Reflection loss is a voltage quantity, so, for example, −20 dB translates into 1/10th of the signal being reflected back, −40 dB translates into 1/100th reflected back, while 0 dB translates into full reflection. Line 1308 shows that the phase filter has relatively low return loss across the 20-40 GHz frequency range.

Returning now to FIG. 9, the dispersion corrected signal out of phase filter 910 is amplified in the 20-40 GHz frequency range via amplifier 912. From there, the amplified signal 913 enters phase lock 914, first at IQ demodulator 916. The function of the IQ demodulator is to shift to base band (in this case, 0-10 GHz on two channels 926 and 928) and separate the in-phase and quadrature components. The signal is first split by splitter 918 and sent to both mixer 920 and mixer 922. Mixed with that signal is a reference signal shifted either 0 degrees (to mixer 920) or 90 degrees (to mixer 922) from hybrid phase shifter 924. One example of a commercially available IQ demodulator is part number MMKKa-10 available from Spacek Labs, Inc. in Santa Barbara, Calif. 93101.

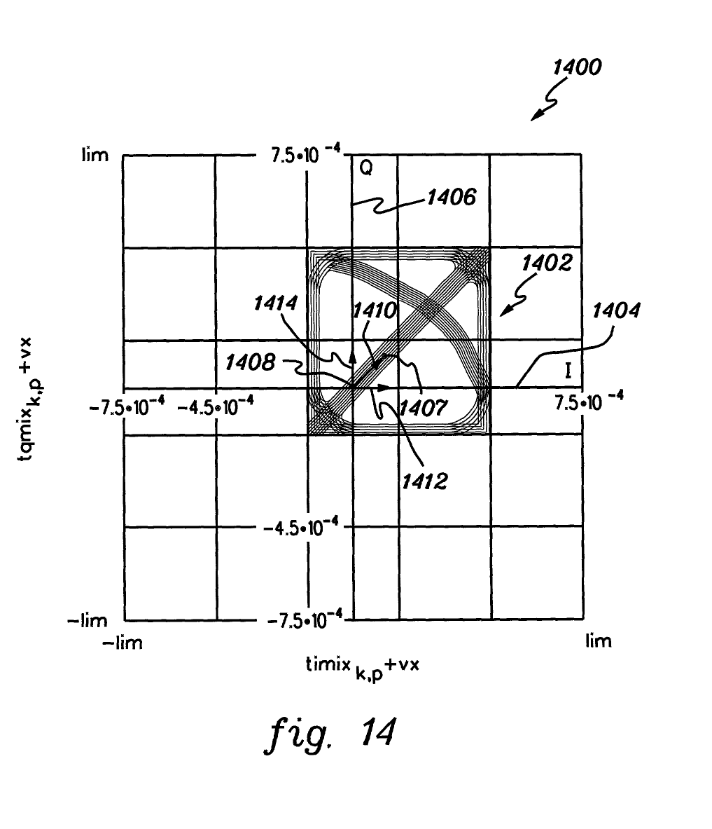

FIG. 14 is a graph 1400 of a quadrature amplitude modulation constellation 1402 for amplified signal 913 prior to being locked by phase lock 914. Graph 1400 includes a horizontal in-phase (I) axis 1404, and a vertical quadrature (Q) axis 1406. The physical center 1407 of constellation 1402 is offset from the origin 1408 by a vector 1410, comprising components Vi 1412 and Vq 1414 along the I and Q axes, respectively. As one skilled in the art will understand, it is necessary to stabilize the constellation in a position on the graph from sampling period to sampling period, or else it would rotate wildly around the origin. The consequence of such wild rotation would be the inability to sample I and Q to clearly extract data. For further information on QAM constellations, see, for example, John G. Proakis, “Digital Communications,” second edition, section 4.5, McGraw-Hill 1989.

Returning again FIG. 9, the signal 926 out of mixer 920 comprises I+Vi, while the signal 928 out of mixer 922 comprises Q+Vq. From there, signals 926 and 928 preferably pass through Bessel filters 930 and 932, respectively, though they are not necessary for the proper operation of receiver 900. As one skilled in the art will know, a Bessel Filter removes unwanted high frequency components, e.g., above 10 GHz. The signals are then sent through Bias T elements 934 and 936, which separate I 938 from Vi 940 and Q 942 from Vq 944. Two examples of commercially available Bias T elements are model nos. 5535 and 5545, intended for 10 Gb/s OC-192 format, from PicoSecond Pulse Labs in Boulder, Colo., USA. The I and Q portions of the signals are both RF and contain the data, while Vi and Vq, both very low frequency signals (typically not higher than about 70 kHz), are DC and do not contain data.

Phase lock 914 further comprises a reference signal generator 954 that receives as inputs the Vi 940 and Vq 944 signal portions from Bias T elements 934 and 936, respectively, and provides as an output a reference signal 956 for local oscillator 958. The local oscillator acts as a source signal 960 (in this example, a 30 GHz source signal) for hybrid phase shifter 924 within IQ demodulator 916. The frequency of the source signal depends, of course, on the transmitter carrier generation, which is 30 GHz in this example.

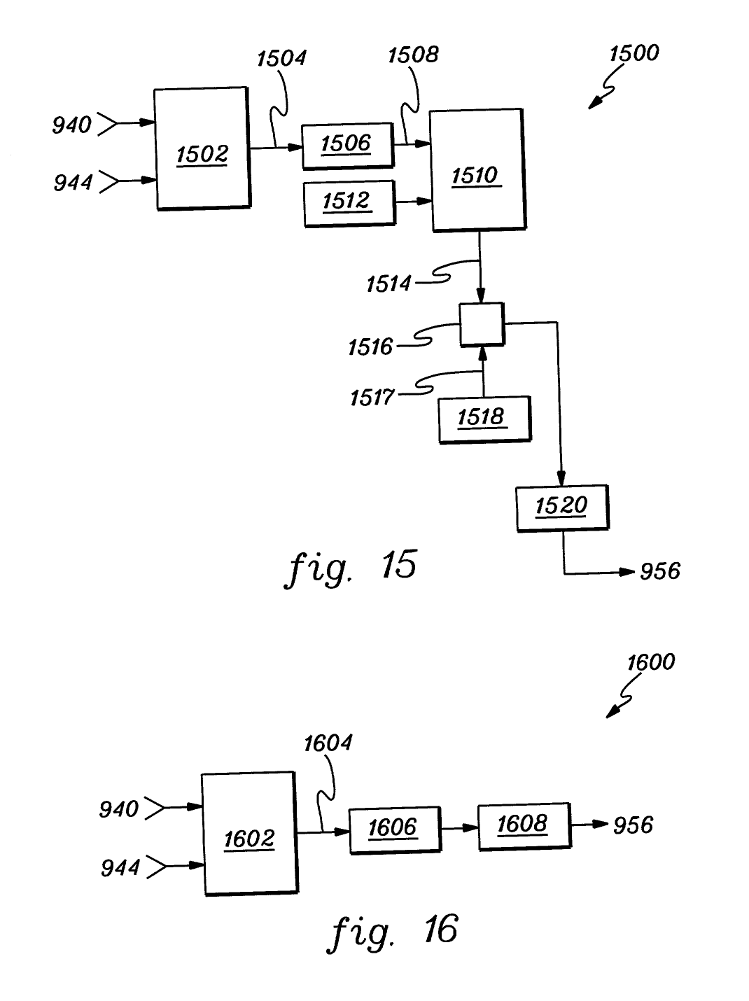

FIG. 15 is a block diagram of one example of a reference signal generator 1500 for the local oscillator of FIG. 9 in accordance with the present invention. As noted with respect to FIG. 9, the inputs to reference signal generator 1500 are the Vi 940 and Vq 944 signals from the Bias T elements. A comparator 1502 produces as an output 1504 the amplified difference between Vi and Vq (i.e., Vi minus Vq). Output 1504 is filtered through low-pass filter 1506, in the present example passing up to about 1 kHz. The filtered difference 1508 is then sent to an integrator 1510 with offset voltage control 1512, which ensures that the filtered difference is brought down to zero. In other words, complementary Vi and Vq signals are being simulated, where necessary. With respect to the constellation graph 1400 of FIG. 14, the integrator with offset control allows for the rotation of vector 1410 about the origin, which in turn allows the constellation to be positioned. In short, the integrator with offset control provides phase control.

Although the output 1514 of integrator 1510 could be sent directly to a voltage controlled crystal oscillator 1520, output 1514 is preferably combined in a combiner 1516 with a voltage 1517 from frequency center control 1518, and sent on to the voltage controlled crystal oscillator. The frequency center control brings the frequency of oscillator 1520 within a predetermined frequency range needed to zero the Vi/Vq difference more accurately. The voltage 1517 can adjust the voltage out of integrator 1510 by about 3 to about 4 volts, for example. In the present example, the voltage controlled crystal oscillator needs to receive a voltage in a range of about 2 to about 15 volts.

Another example of a reference signal generator 1600 for the local oscillator 958 of FIG. 9 is shown in FIG. 16. The Vi 940 and Vq 944 signals are inputs to a computing unit 1602, which can be programmed to perform the functions of the comparator, integrator with offset control, and optional combiner with frequency center control. The computing unit includes, for example, one or more central processing units, memory, one or more storage devices and one or more input/output devices, as is well known in the art. The output 1604 of computing unit 1602 is filtered through a low-pass filter 1606 similar to filter 1506 in FIG. 15, and on to voltage controlled crystal oscillator 1608, similar to oscillator 1520 of FIG. 15.

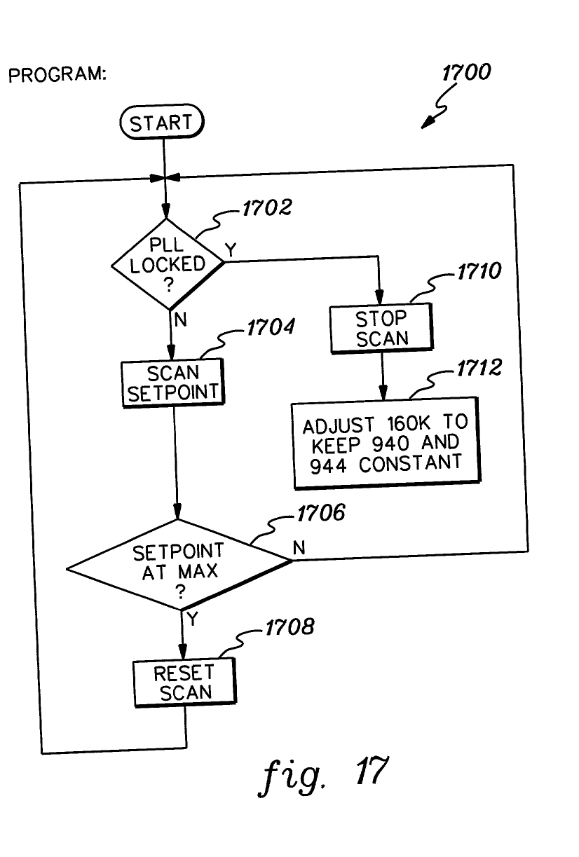

FIG. 17 is a flow diagram 1700 of one example of the operation of computing unit 1602 in order to accomplish the functions of the comparator, integrator with offset control and optional combiner with frequency center control. An inquiry 1702 is first made as to whether the PLL is locked. If the PLL is not locked, then the set point is scanned (step 1704). By “scanned” it is meant that a sweep is performed starting at a frequency below the expected frequency of operation and stopping at a frequency above the expected frequency of operation. The expected frequency of operation is the frequency that the PLL is intended to operate at (e.g., 30 GHz exactly). Due to imperfect components, the real frequency of the carrier generated at the transmitter may be slightly off this 30 GHz number. Therefore, the PLL has a frequency range large enough to at least cover the range of possible carrier frequencies generated by a transmitter. The PLL starts the sweep at a frequency below the lowest possible transmitter carrier frequency and stops at a frequency higher than the highest possible transmitter carrier frequency. Thus, it is ensured that the actual transmitter carrier frequency will be within the PLL frequency sweep. The process of bringing the frequency to within phase locking bandwidth of the PLL is known as “frequency lock.” As soon as the PLL frequency is equal to the transmitter carrier frequency, it is detected, because at that point the Vi and Vq signals do not vary much anymore such that their frequency of variation is within the PLL phase locking bandwidth. At that point, the PLL control loop will instantly react to any remaining small frequency difference that may still exist between PLL frequency and transmitter carrier frequency and bring the difference to zero. The PLL control loop will further act on Vi and Vq such that these are compared to a reference voltage and any difference with the reference voltage is nulled (known as “phase lock”). This in effect keeps Vi and Vq constant.

Next, an inquiry 1706 is made as to whether the set point is at the maximum (i.e., the maximum drive voltage into the PLL). If the set point is not at the maximum, then inquiry 1702 is returned to. If the set point is at the maximum, then the scan is reset (step 1708), and inquiry 1702 is returned to. If inquiry 1702 is positive, then the scan is stopped (step 1710), and the PLL phase is adjusted (step 1712) to keep the Vi 940 and Vq 944 signals constant.

Returning now to FIG. 9, the I 938 and Q 942 signals continue out of the Bias T elements through 0-10 GHz amplifiers 946 and 948, respectively, and then on to clock and data recovery circuits 950 and 952, respectively, for data extraction. As one skilled in the art will know, the clock and data recovery circuits reconstruct the clock and data as it was on the transmitter side. One example of a commercially available clock and data recovery circuit is model no. MOS43CM, intended for the OC-192 format, from NEL America, Inc. in Saddle Brook, N.J., USA.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A method of receiving digital information from an input optical signal, comprising:
receiving an optical signal containing digital information, wherein the optical signal comprises an in-phase (I) component, a quadrature (Q) component and a carrier signal; and
phase locking the I component and the Q component.

2. The method of claim 1, wherein the receiving comprises converting the optical signal to an electrical signal, and wherein the phase locking is performed on the electrical signal.

3. The method of claim 2, wherein the converting is accomplished with a photodetector.

4. The method of claim 2, further comprising phase filtering the electrical signal to compensate for dispersion.

5. The method of claim 4, wherein the receiving comprises receiving the optical signal from an optical wave guide, and wherein the phase filtering comprises applying additional dispersion to the electrical signal having a group delay substantially opposite that of the optical wave guide.

6. The method of claim 2, wherein the phase locking comprises:
separating the in-phase component from the quadrature component, wherein each of the in-phase component and the quadrature component includes a Direct Current (DC) portion and a Radio Frequency (RF) portion;
separating the DC portion from the RF portion for each of the in-phase component and the quadrature component, wherein the digital information comprises the RF portion for both the in-phase component and the quadrature component; and
adjusting the DC portion for the in-phase component and the DC portion for the quadrature component so as to be complementary.

7. The method of claim 6, wherein separating the in-phase component from the quadrature component comprises employing an IQ demodulator.

8. The method of claim 6, wherein separating the DC portion from the RF portion for each of the in-phase component and the quadrature component comprises employing a bias-T element for each of the in-phase component and the quadrature component.

9. The method of claim 6, wherein the adjusting comprises:
comparing the DC portion of the in-phase component with the DC portion of the quadrature component to obtain a difference signal; and
zeroing the difference signal to produce a zeroed difference signal.

10. The method of claim 9, wherein separating the in-phase component from the quadrature component comprises separating with an IQ demodulator, and wherein the phase locking further comprises:
generating a reference signal for a local oscillator based on the zeroed difference signal, wherein the local oscillator provides a reference signal to the IQ demodulator.

11. The method of claim 10, wherein the generating comprises generating the reference signal for the local oscillator with a voltage controlled crystal oscillator.

12. The method of claim 11, wherein the comparing is accomplished with a comparator.

13. The method of claim 11, wherein the zeroing is accomplished with an integrator and offset voltage control.

14. The method of claim 11, further comprising adjusting a voltage provided to the voltage controlled crystal oscillator.

15. The method of claim 14, wherein adjusting the voltage comprises combining a voltage signal with the zeroed difference signal to produce an adjusted signal for providing to the voltage controlled crystal oscillator.

16. The method of claim 9, wherein the comparing and zeroing are accomplished via a computer unit.

17. The method of claim 1, wherein the carrier signal comprises a single offset frequency.

18. The method of claim 17, wherein the single offset frequency comprises +30 GHz or −30 GHz from a data band center.

19. The method of claim 17, wherein the single offset frequency comprises an integer multiple of half a bit rate for the optical signal.

20. A receiver for receiving digital information from an optical signal, comprising:
an optical receiver for receiving an optical signal, comprising an in-phase (I) component, a quadrature (Q) component and a carrier signal; and
a phase lock for locking the I component and the Q component.

21. The receiver of claim 20, wherein the optical receiver converts the optical signal to an electrical signal, and wherein the phase lock operates on the electrical signal.

22. The receiver of claim 21, wherein the optical receiver comprises a photodetector.

23. The receiver of claim 21, further comprising a phase filter for filtering the electrical signal to compensate for dispersion.

24. The receiver of claim 23, wherein the phase filter compensates for dispersion from an optical wave guide, and wherein the phase filter comprises means for applying additional dispersion to the electrical signal having a group delay substantially opposite that of the optical wave guide.

25. The receiver of claim 21, wherein the phase lock comprises an IQ demodulator for separating the I component from the Q component.

26. The receiver of claim 25, wherein each of the I component and the Q component includes a Direct Current (DC) portion and a Radio Frequency (RF) portion, and wherein the phase lock further comprises a bias T element for each of the I component and the Q component to separate the DC portion from the RF portion.

27. The receiver of claim 26, wherein the phase lock further comprises a local oscillator for providing a reference signal to the IQ demodulator.

28. The receiver of claim 27, wherein the phase lock further comprises a reference signal generator for generating a reference signal for the local oscillator based on the DC portion of the I component and the DC portion of the Q component.

29. The receiver of claim 28, wherein the reference signal generator comprises a voltage controlled crystal oscillator.

30. The receiver of claim 29, wherein the reference signal generator further comprises a comparator for producing a signal representing a difference between the DC portion of the I component and the DC portion of the Q component.

31. The receiver of claim 30, wherein the reference signal generator further comprises an integrator with offset voltage control for zeroing the difference.

32. The receiver of claim 31, wherein the reference signal generator further comprises:
a frequency center control for providing a voltage to adjust a voltage out of the integrator; and
a combiner for combining the voltages from the frequency center control and the integrator.

33. The receiver of claim 29, wherein the reference signal generator further comprises a computing unit programmed to:
compare the DC portion of the I component and the DC portion of the Q component;
zero a difference between DC portion of the I component and the DC portion of the Q component; and
adjust a voltage output to be within a range needed for the voltage controlled crystal oscillator.

34. The receiver of claim 28, wherein the reference signal generator comprises a filter.

35. The receiver of claim 20, wherein the carrier signal comprises a single offset frequency.

36. The receiver of claim 35, wherein the single offset frequency comprises +30 GHz or −30 GHz from a data band center.

37. The receiver of claim 35, wherein the single offset frequency comprises an integer multiple of half a bit rate for the optical signal.

38. A receiver for receiving digital information from an optical signal, comprising:
an optical receiver for receiving an optical signal, comprising an in-phase (I) component, a quadrature (Q) component and a carrier signal, and generating an electrical signal representative thereof;
a phase filter for dispersion compensation of the electrical signal;
an IQ demodulator for separating the I component from the Q component, wherein each of the I component and the Q component includes a Direct Current (DC) portion and a Radio Frequency (RF) portion;
a bias-T element for each of the I component and the Q component to separate the DC portion from the RF portion;
a local oscillator for providing a reference signal to the IQ demodulator; and
a reference signal generator for providing a reference signal to the local oscillator based on the DC portion of each of the I component and the Q component.

39. The receiver of claim 38, wherein the optical receiver comprises a photodetector.

40. The receiver of claim 38, wherein the reference signal generator comprises:
a comparator for comparing the DC portion of the I component and the DC portion of the Q component to provide a difference signal;
an integrator with offset control for receiving and zeroing the difference signal; and
a voltage controlled crystal oscillator for providing a reference signal to the local oscillator based on an output signal from the integrator.

41. The receiver of claim 40, wherein the reference signal generator further comprises:
a filter for filtering and providing the difference signal to the integrator;
a frequency center control for providing a voltage to adjust a voltage out of the integrator; and
a combiner for combining the voltage from the integrator with the voltage from the frequency center control to produce a control voltage for the voltage controlled crystal oscillator.

42. The receiver of claim 38, wherein the reference signal generator comprises:
a computing unit for comparing the DC portion of the I component and the DC portion of the Q component and zeroing the difference;
a filter for filtering an output signal from the computing unit; and
a voltage controlled crystal oscillator for providing a reference signal to the local oscillator based on the output signal from the computing unit.

43. Apparatus to compensate for optical signal dispersion from an optical wave guide of known length, comprising a phase filter having a group delay substantially opposite that of the optical wave guide.

44. The apparatus of claim 43, wherein the phase filter comprises a plurality of broadside-coupled microwave strip lines.

45. A method of compensating for dispersion of an optical signal from an optical wave guide of known length, comprising applying additional dispersion having a group delay substantially opposite that of the optical wave guide.

46. The method of claim 45, wherein the applying comprises:
generating an electrical signal representative of the optical signal; and
apply the additional dispersion to the electrical signal.

47. A system for optically transferring information, comprising:
a transmitter for transmitting an optical signal comprising a carrier signal, an in-phase (I) component and a quadrature (Q) component;
an optical wave guide for transferring the optical signal; and
a receiver, comprising:
an optical receiver for receiving the optical signal; and
a phase lock for locking the I component and the Q component.

48. The system of claim 47, wherein the transmitter comprises:
an optical carrier signal generator for generating an optical carrier signal having a first polarization state;
an optical data signal generator for generating an optical data signal separate from the optical carrier signal and having a second polarization state; and
means for matching the first polarization state and the second polarization state.

49. The system of claim 47, wherein the optical carrier signal generator is capable of generating an optical carrier signal with a dominant second order harmonic.

50. The system of claim 47, wherein the optical carrier signal generator is capable of suppressing odd harmonics.

51. The system of claim 47, wherein the optical carrier signal generator comprises a radio frequency (RF) signal generator for generating at least one Radio Frequency (RF) signal.

52. The system of claim 51, wherein the optical carrier signal generator further comprises at least one phase modulator for modulating radiation with the at least one RF signal to produce at least one modulated signal.

53. The system of claim 52, wherein the at least one RF signal comprises a first RF signal and a second RF signal, wherein the at least one phase modulator comprises a first phase modulator and a second phase modulator, and wherein the optical carrier signal generator further comprises a phase shifter for phase shifting a phase modulated signal from one of the first phase modulator and the second phase modulator to produce a phase shifted signal.

54. The system of claim 53, wherein the optical carrier signal generator further comprises a combiner for combining the phase shifted signal with a phase modulated signal from the other of the first phase modulator and the second phase modulator.

55. The system of claim 48, wherein the optical data signal generator comprises at least one electrical data signal generator.

56. The system of claim 55, wherein the optical data signal generator further comprises at least one amplifier for amplifying the at least one electrical data signal to produce an amplified signal.

57. The system of claim 56, wherein the at least one amplifier comprises a modulator driver.

58. The system of claim 56, wherein the optical data signal generator further comprises at least one modulator for modulating radiation with the amplified signal to produce a modulated data signal.

59. The system of claim 58, wherein the at least one modulator modulates the optical carrier signal with the amplified signal to produce the optical data signal.

60. The system of claim 58, wherein the at least one modulator comprises a Mach-Zehnder interferometric modulator.

61. The system of claim 58, wherein the at least one electrical data signal generator comprises a first electrical data signal generator and a second electrical data signal generator, wherein the at least one amplifier comprises a first amplifier and a second amplifier, wherein the at least one modulator comprises a first modulator and a second modulator, and wherein the optical data signal generator further comprises:
at least one phase shifter for phase shifting the radiation to one of the first modulator and the second modulator; and
a combiner for combining a first modulated signal from the first modulator and a second modulated signal from the second modulator to produce the optical data signal.

62. The system of claim 61, wherein the at least one phase shifter comprises a first phase shifter and a second phase shifter for phase shifting the radiation to the one of the first modulator and the second modulator and phase shifting a combined signal out of the combiner, and wherein the optical data signal generator further comprises an attenuator for attenuating a signal out of the second phase shifter to produce the optical data signal.

63. The system of claim 47, wherein the means for matching comprises polarization maintaining optical fiber.

64. The system of claim 47, wherein the means for matching comprises a single crystal comprising the optical carrier signal generator and the optical data signal generator.

65. The system of claim 47, wherein the optical wave guide 60 comprises a long-haul optical fiber.

66. The system of claim 65, wherein the long-haul optical fiber comprises a single-mode optical fiber.

67. The system of claim 47, wherein the optical receiver converts the optical signal to an electrical signal, and wherein the phase lock operates on the electrical signal.

68. The system of claim 67, wherein the optical receiver comprises a photodetector.

69. The system of claim 67, further comprising a phase filter for filtering the electrical signal to compensate for dispersion.

70. The system of claim 69, wherein the phase filter comprises a plurality of broadside coupled lines.

71. The system of claim 69, wherein the phase filter compensates for dispersion from an optical wave guide, and wherein the phase filter comprises means for applying additional dispersion to the electrical signal having a group delay substantially opposite that of the optical wave guide.

72. The system of claim 67, wherein the phase lock comprises an IQ demodulator for separating the I component from the Q component.

73. The system of claim 72, wherein each of the I component and the Q component includes a Direct Current (DC) portion and a Radio Frequency (RF) portion, and wherein the phase lock further comprises a bias T element for each of the I component and the Q component to separate the DC portion from the RF portion.

74. The system of claim 73, wherein the phase lock further comprises a local oscillator for providing a reference signal to the IQ demodulator.

75. The system of claim 74, wherein the phase lock further comprises a reference signal generator for generating a reference signal for the local oscillator based on the DC portion of the I component and the DC portion of the Q component.

76. The system of claim 75, wherein the reference signal generator comprises a voltage controlled crystal oscillator.

77. The system of claim 76, wherein the reference signal generator further comprises a comparator for producing a signal representing a difference between the DC portion of the I component and the DC portion of the Q component.

78. The system of claim 77, wherein the reference signal generator further comprises an integrator with offset voltage control for zeroing the difference.

79. The system of claim 78, wherein the reference signal generator further comprises:
a frequency center control for providing a voltage to adjust a voltage out of the integrator; and
a combiner for combining the voltages from the frequency center control and the integrator.

80. The system of claim 76, wherein the reference signal generator further comprises a computing unit programmed to:
compare the DC portion of the I component and the DC portion of the Q component;
zero a difference between DC portion of the I component and the DC portion of the Q component; and
adjust a voltage output to be within a range needed for the voltage controlled crystal oscillator.

81. The system of claim 75, wherein the reference signal generator comprises a filter.

82. The system of claim 47, wherein the carrier signal comprises a single offset frequency.

83. The system of claim 82, wherein the single offset frequency comprises +30 GHz or −30 GHz from a data band center.

84. The system of claim 82, wherein the single offset frequency comprises an integer multiple of half a bit rate for the optical signal.
